(19) United States
(12) Patent Application Publication
(10) Pub. No.: US 2016/0062149 A1
(43) Pub. Date: Mar. 3, 2016

(54) Replaceable Light Filter for Diving Mask and Method for Replacement

(71) Applicant: Jeff Gerton, Kailua Kona, HI (US)

(72) Inventor: Jeff Gerton, Kailua Kona, HI (US)

(21) Appl. No.: 14/835,023

(22) Filed: Aug. 25, 2015

Related U.S. Application Data
(60) Provisional application No. 62/045,298, filed on Sep. 3, 2014.

(51) Int. Cl. G02C 7/10; G02C 9/00; B63C 11/12; G02C 3/02

(52) U.S. Cl. CPC G02C 7/104; G02C 3/02; G02C 9/00; B63C 11/12; B63C 2011/128

(57) ABSTRACT

The invention is a device for adjusting underwater viewing. The device comprises a shaped lens consisting of a thin, transparent, tinted material. The shaped lens is an additive color filter configured to add missing wavelengths to light propagating through the shaped lens, the missing wavelengths being within a range of 577 nm to 750 nm. The shaped lens is configured to be removably secured to the visor of a diving mask. The device may further comprise one or more suction cups, one or more clips, or a strap disposed through openings in the lens. The device may further comprise a means for attaching the lens to the visor of a diving mask.

### PRIORITY

This application claims priority to U.S. provisional patent application Ser. No. 62/045,298 filed on Sep. 3, 2014.

### FIELD OF THE INVENTION

The invention relates generally to masks for scuba diving and more specifically to a replaceable color filter and diving mask for use to enhance underwater visibility.

### BACKGROUND OF INVENTION

Underwater scuba diving is a popular recreational activity. Recreational scuba divers normally dive to a depth range of thirty to forty meters. As divers go deeper underwater light from the surface is absorbed by the water until the light completely disappears and the water is dark. Light waves are filtered out of the water at different rates.

Water is about eight hundred times denser than air. As light enters the water, the water molecules and suspended particles cause a loss in the intensity of light, a change in the color of the light, a loss of contrast, and diffusion of the light. As light passes through water, longer wavelengths in the red area of the visible spectrum are absorbed faster than shorter wavelengths in the blue are of the visible spectrum. Loss of the color red is dramatic. By a depth of five meters nearly ninety percent of the color red is lost. After the color red, the color orange and the color yellow are filtered out of the water. The result is that at a certain depth only light from the blue end of the spectrum remains.

The loss of certain colors can be remedied in two ways. In one manner, a diver can take an external light source under water. These external light sources shine white light and replace the lost wavelengths. In a second manner, a color filter can be used to add the missing color back in. Special diving masks are known to utilize tinted glass where the glass is tinted red or yellow to add the missing color back in as the diver views the surroundings.

Both methods have their limitations. Carrying an external light source can be tiring on the diver. Additionally, the batteries for the light source may expire and the light may cease to work. The diving masks are limited in that the additional tinting is unnecessary at shallower depths. Also, a diver is unable to change the color of the filter used during any dive since the tinting is incorporated into the glass. What is needed is a diving mask that permits a diver to change the tinting of the mask based on the anticipated depth of the dive prior to diving or while diving.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The invention is directed toward a device for adjusting underwater viewing. The device comprises a shaped lens consisting of a thin, transparent, tinted material, the shaped lens having a first side, the first side being a substantially flat, planar surface, a second side, the second side being a substantially flat, planar surface, and a peripheral edge disposed between the first side and the second side. The shaped lens is an additive color filter configured to add missing wavelengths to light propagating through the shaped lens, the missing wavelengths being within a range of 577 nm to 750 nm. The shaped lens is configured to be removably secured to the visor of a diving mask.

In another embodiment, the shaped lens is a thermoplastic material. In another embodiment, the shaped lens has a left portion and a right portion, the left portion and the right portion being mirrored images, the right portion and the left portion being substantially oval in shape. In another embodiment, the shaped lens is an electrostatic material configured to cling to glass or thermoplastic. In another embodiment, the device further comprises a means for removably securing the shaped lens to the visor of a diving mask. In another embodiment, the device further comprises one or more suction cups disposed on the first side of the shaped lens. In another embodiment, the device further comprises one or more clips disposed on the peripheral edge of the shaped lens. In another embodiment, the shaped lens has one or more openings, and the device further comprises a strap and one or more strap clips disposed on the strap. The strap passes through one of the one or more openings in the shaped lens. The strap forms two loop sections, one loop section being disposed laterally from the right portion of the shaped lens and one loop section being disposed laterally from the left portion of the shaped lens.

In another embodiment, the device comprises two shaped lens, each of the shaped lenses consisting of a thin, transparent, tinted material, the each of the shaped lenses having a first side, the first side being a substantially flat, planar surface, a second side, the second side being a substantially flat, planar surface, and a peripheral edge disposed between the first side and the second side. Each of the shaped lenses is an additive color filter configured to add missing wavelengths to light propagating through the shaped lens, the missing wavelengths being within a range of 577 nm to 750 nm. Each of the shaped lenses is configured to be removably secured to the visor of a diving mask.

Each of the shaped lenses may be a thermoplastic material. Each of the shaped lenses may be substantially oval in shape. In another embodiment, the device further comprises a means for removably securing each of the shaped lenses to the visor of a diving mask. In another embodiment, the device further comprises one or more suction cups disposed on the first side of each of the shaped lenses. In another embodiment, the device further comprises one or more clips disposed on the peripheral edge of each of the shaped lenses. In another embodiment, each of the shaped lenses has one or more openings and the device further comprises a strap and one or more strap clips disposed on the strap. The strap passes through one of the one or more openings in each of the shaped lenses. The strap forms two loop sections, one loop section being disposed laterally from one shaped lens and one loop section being disposed laterally from the other shaped lens.

The invention is also directed toward the method of enhancing the view from an underwater diving mask. The method comprises removably securing a shaped lens to the visor of a diving mask, the shaped lens being an additive color filter configured to add missing wavelengths to light propagating through the shaped lens, the missing wavelengths being within a range of 577 nm to 750 nm, and placing the diving mask bearing the shaped lens into an underwater environment. The method may further comprise detaching the shaped lens from the diving mask while the diving mask is in the underwater environment, selecting an alternative shaped lens, and removably securing the alternative shaped lens to the visor of the diving mask while in the underwater environment.

Still other embodiments of the present invention will become readily apparent to those skilled in this art from the following description wherein there is shown and described the embodiments of this invention, simply by way of illustration of the best modes suited to carry out the invention. As it will be realized, the invention is capable of other different embodiments and its several details are capable of modifications in various obvious aspects all without departing from the scope of the invention. Accordingly, the drawing and descriptions will be regarded as illustrative in nature and not as restrictive.

### BRIEF DESCRIPTION OF THE DRAWINGS

Various exemplary embodiments of this invention will be described in detail, wherein like reference numerals refer to identical or similar components, with reference to the following figures, wherein:

FIG. 1 is a plan view of an embodiment of the removable color filter;

FIG. 2 is a plan view of an embodiment of the removable color filter;

FIG. 3 is a plan view of an embodiment of the removable color filter;

FIG. 4 is a plan view of an embodiment of the removable color filter;

FIG. 5 is a plan view of an embodiment of a bifurcated removable color filter;

FIG. 6 is a plan view of an embodiment of a bifurcated removable color filter;

FIG. 7 is a plan view of an embodiment of a bifurcated removable color filter;

FIG. 8 is a plan view of an embodiment of a bifurcated removable color filter;

FIG. 9 is an isometric view of a diving mask with a removable color filter;

FIG. 10 is an isometric view of a diving mask with a removable color filter;

FIG. 11 is an isometric view of a diving mask with a removable color filter; and

FIG. 12 is a schematic of the method of use of the removable color filter.

### DETAILED DESCRIPTION OF THE PREFERRED EMBODIMENT

The claimed subject matter is now described with reference to the drawings. In the following description, for purposes of explanation, numerous specific details are set forth in order to provide a thorough understanding of the claimed subject matter. It may be evident, however, that the claimed subject matter may be practiced with or without any combination of these specific details, without departing from the spirit and scope of this invention and the claims.

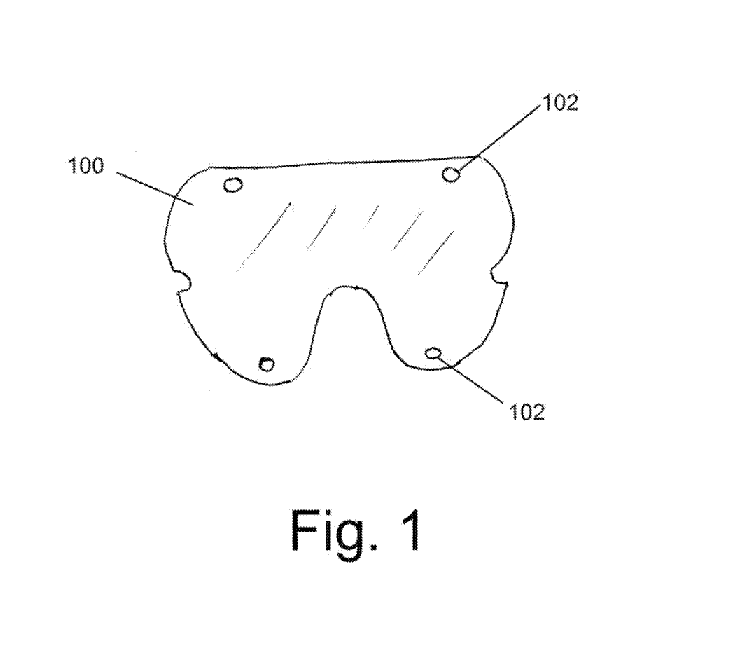

The invention is directed toward an interchangeable color optical filter for use on a diving mask and method for replacing the optical filter. Referring to FIG. 1, the preferred embodiment of the optical filter 100 is illustrated. The optical filter 100 is shaped to fit a standard shaped diving mask. The optical filter 100 is configured to add wavelengths missing from the light in the water beyond a certain depth. The optical filter 100 is an additive color filter which may add the color yellow (wavelength range of 577 nm to 590 nm), the color orange (wavelength range of 590 nm to 620 nm), the color red (wavelength range of 620 nm to 750 nm), or any combination thereof to the light passing through the optical filter 100.

In one embodiment the diving mask utilized is any standard diving mask. The interchangeable color filter 100 in this embodiment is a shaped color film, which adheres to the glass portion of the mask. The color filter 100 may be made from any type of material, such as plastic or glass. In the preferred embodiment the color filter 100 is composed of a thermoplastic, such as polyethylene or PET. The color filter 100 may be one continuous piece or a combination of multiple pieces. The color filter 100 may be any shape and thickness. The color filter 100 may be transparent, translucent, or opaque. The color filter 100 may be any color. The color of the color filter 100 may be mixed in to the material or painted onto the surface of the material.

In this embodiment the color filter 100 adheres to the outside surface of the diving mask. The color filter 100 may adhere to the glass by any means. In one means, the color filter 100 adheres to the glass with the use of a chemical adhesive. In another means, the color filter 100 adheres to the glass by means of a static cling. The color filter 100 may be flexible or rigid. If the color filter 100 is flexible the color filter 100 can be easily removed manually by lifting a corner of the color filter 100 and peeling the color filter 100 away from the glass. If the color filter 100 is rigid then the color filter 100 can be removed by pulling the color filter 100 off of the glass. As shown in FIG. 1, the color filter 100 may have a plurality of openings 102. The color filter 100 may have any number of openings 102. The openings 102 may provide a gripping point for removal of the color filter 100 from the diving mask.

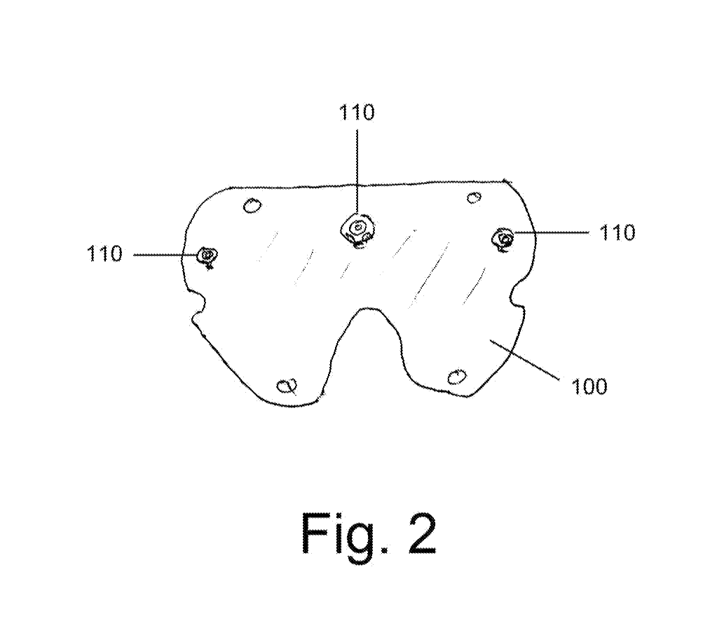

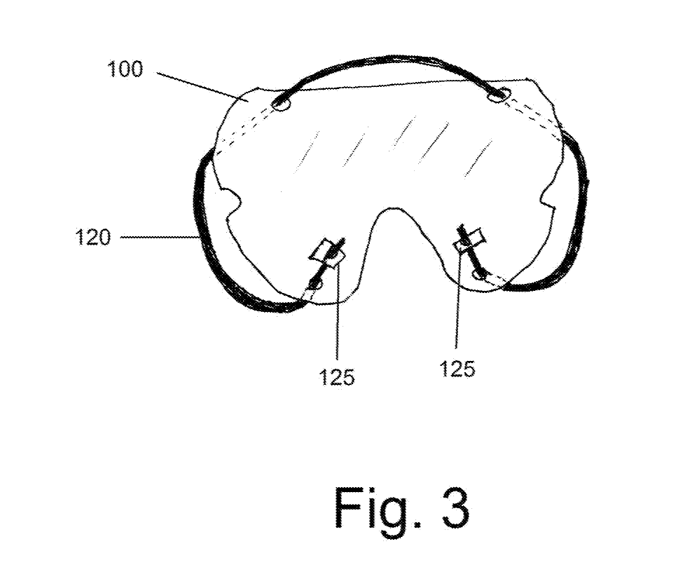

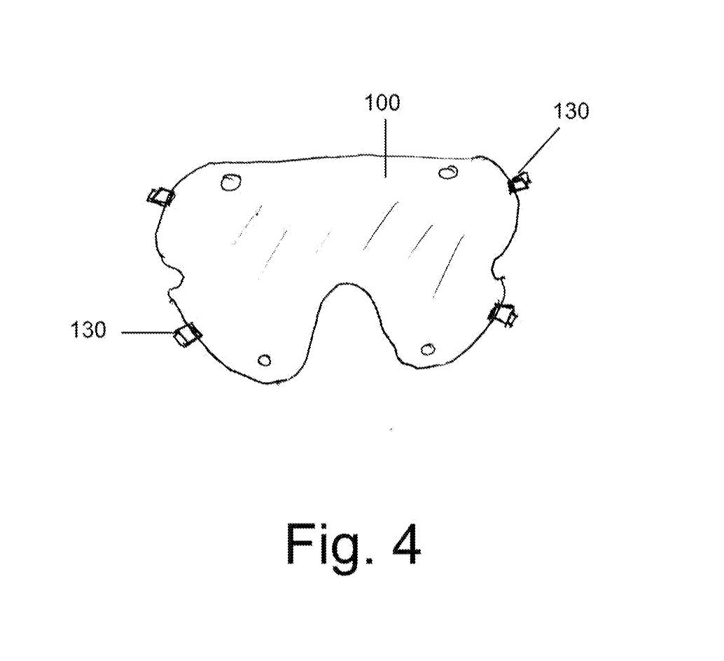

The color filter 100 may be adhered to the glass of the diving mask by any number of means. As shown in FIG. 2, the color filter 100 may have one or more suction cups 110 disposed on the surface of one side of the color filter 100. The suction cups 110 can be pressed up against the glass surface of the diving mask to secure the color filter 100 to the diving mask. The suctions cups 110 can be present in any number and any arrangement. As shown in FIG. 3, the color filter 100 may have a strap 120 passing through a number of the openings 102. The strap 120 may be made out of any type of material. The strap 120 may be a continuous circular strip or an elongated segment. The strap 120 may be a fabric string. The strap 120 may be elastic and stretchable. The strap 120 may be configured in any arrangement and pass through any number of openings 102. In the preferred arrangement the strap 120 has a loop disposed on each side of the color filter 100 for securing to a diving mask. If the strap 120 is an elongated segment then the strap 120 may have a strap clip 125 disposed on each free end of the strap 120. Each of the strap clips 125 may be any type of clip configured to be removably secured to the free ends of the strap 120. The strap clips 125 prevent the free ends of the strap 120 from passing through the openings 102 of the color filter 100. As shown in FIG. 4, the color filter 100 may have a plurality of clips 130 which can be used to physically clip the color filter to a diving mask.

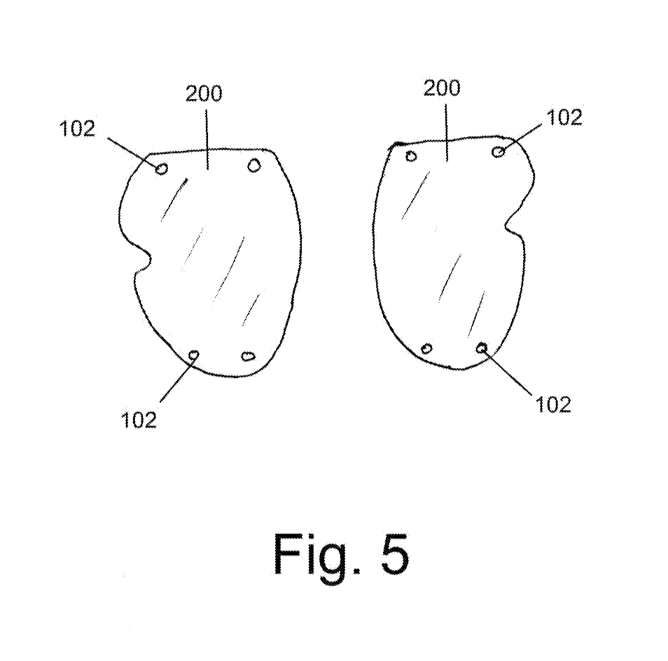

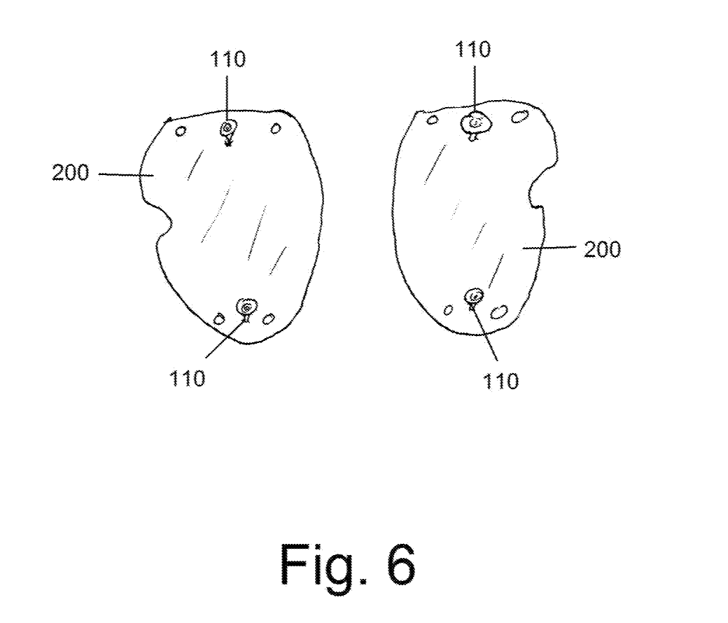

In another embodiment the color filter 100 can be divided into two or more sections, as shown in FIG. 5 through FIG. 8. Referring to FIG. 5, the preferred embodiment of the color filter sections 200 are displayed. The color filter sections 200 are preferred for diving masks having two separated panes of glass disposed on the front of the mask. Each of the color filter sections 200 may have a plurality of openings 102. Each of the color filter sections 200 show in FIG. 5 can be removably secured to the glass of a diving mask by means of a static cling. As shown in FIG. 6, each of the color filter sections 200 may have one or more suction cups 110 disposed on the surface of one side of the color filter sections 200. The suction cups 110 can be pressed up against the glass surface of the diving mask to secure the color filter sections 200 to the diving mask. The suctions cups 110 can be present in any number and in any arrangement on the color filter sections 200.

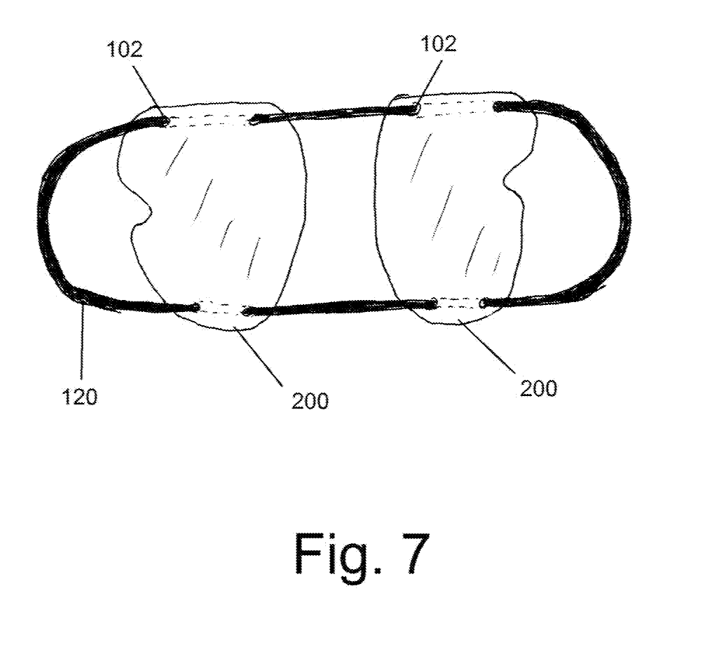

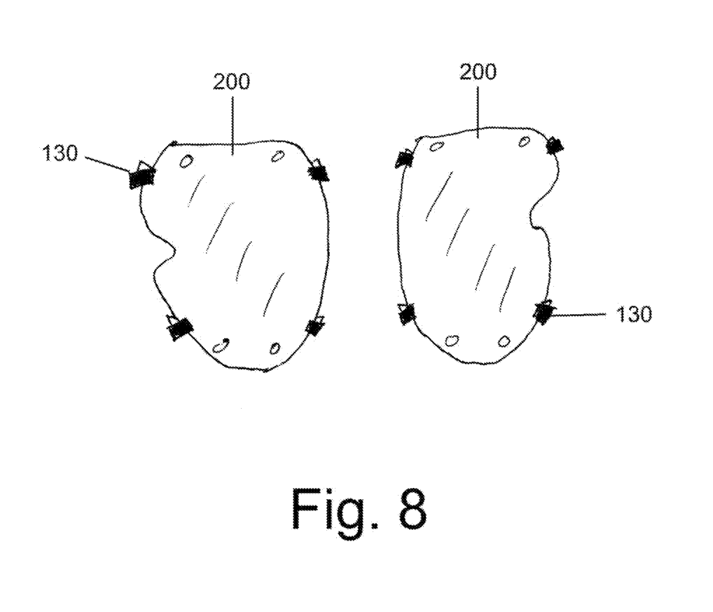

As shown in FIG. 7, the color filter sections 200 may have a strap 120 passing through a number of the openings 102. The strap 120 may be made out of any type of material. The strap 120 may be a continuous circular strip or an elongated segment. The strap 120 may be a fabric string. The strap 120 may be elastic and stretchable. The strap 120 may be configured in any arrangement and pass through any number of openings 102. In the preferred arrangement the strap 120 has a loop disposed on each side of the two color filter sections 200 for securing to a diving mask. Although the strap 120 illustrated in FIG. 7 is a continuous strip, the strap 120 may also have one or more strap clips 125 for securing strap 120 to itself to allow a user to quickly adjust the length or tension of the strap 120. As shown in FIG. 8, the color filter sections 200 may have a plurality of clips 130 which can be used to physically clip the color filter to a diving mask.

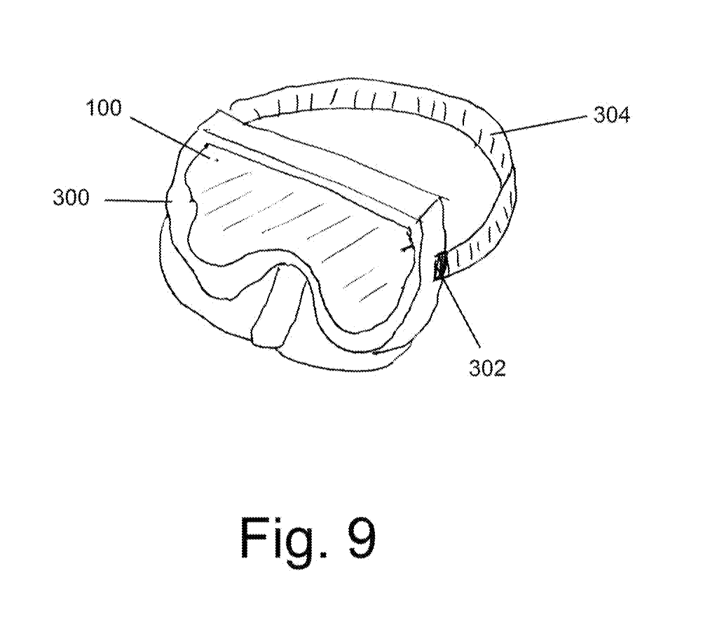

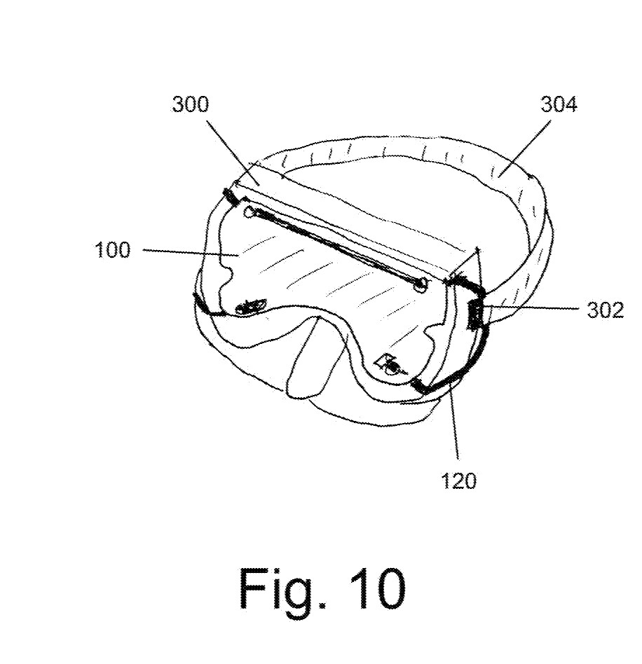

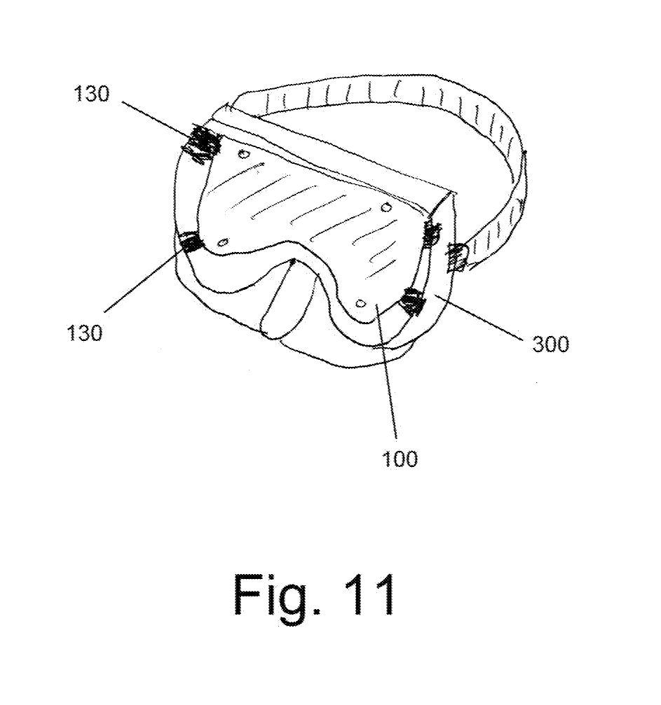

Referring to FIG. 9, the color filter 100 being removably secured to the diving mask 300 is illustrated. As shown in FIG. 9, the color filter 100 is attached to the glass of the diving mask 300, which may be attached by either static cling or suction cups 110. The diving mask 300 has an adjustable band 304 which is attached to the mask 300 at an attachment point 302. As shown in FIG. 10, the color filter 100 is removably secured to the diving mask 300 by a strap 120. In one embodiment, the strap 120 passes behind the attachment point 302 and underneath the adjustable band 304 on each side of the diving mask 300. In other embodiments the strap 120 may be secured to the head of the user or the outside of the mask 300. As show in FIG. 11, the color filter 100 is removably secured to the diving mask 300 by a plurality of clips 130. There may be any number of clips 130 present in any arrangement. The clips 130 have two separate arms that can be compressed together over external ridges of the diving mask 300 to form a frictional hold by the clips 130 onto the diving mask 300.

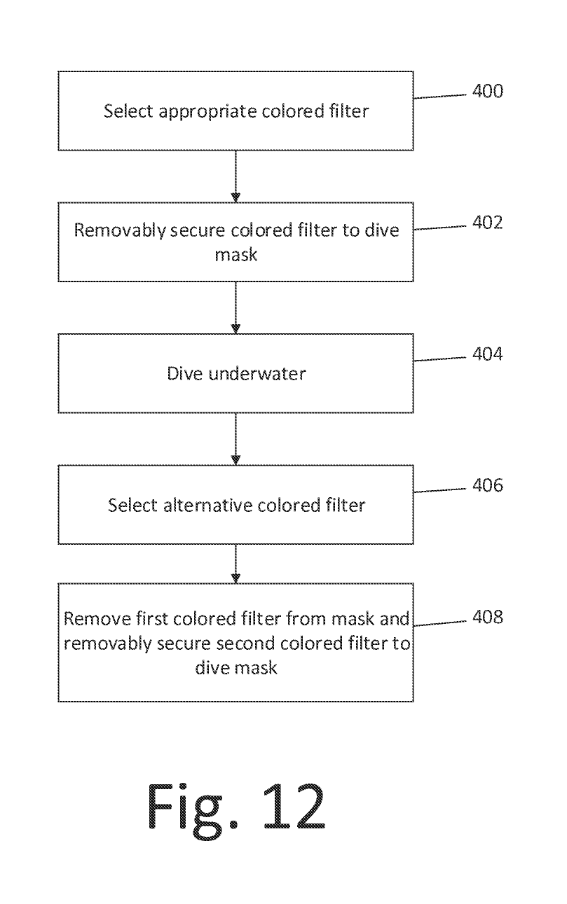

Referring to FIG. 12, the method of utilizing the color filter is illustrated. First, the user selects the appropriate color filter for placement on the mask 400. Then the user removably secures the color filter to the dive mask 402. The user proceeds to dive underwater while wearing the mask 404. If the user desires, the user can select an alternative color filter while underwater 406. Finally, while remaining underwater, the user can remove the first color filter from the diving mask and removably secure the second color filter to the diving mask 408.

In this embodiment the diver may change the color filter 100 at any time. For instance, if the diver is diving in a particular spot where a yellow filter may work better the diver may apply a yellow filter to the diver mask. If the diver later moves to a different location where a red filter may work better, then the diver may remove the yellow filter and apply the red filter. In one embodiment, the diver may take multiple color filters 100 underwater on a dive and change color filter 100 while underwater. As the diver reaches different depths the diver may desire to change his or her perception and change the filter while underwater. The diver then removes the current filter and then applies the new filter. The diver may use a standard diving mask with no color filter 100 as well at any time during the dive and then apply the color filter 100 to the mask for those times when the diver desires to utilize the color filter 100.

The color filters 100 may be provided to divers in any manner sufficient for the diver to obtain the color filter needed. The color filters may be provided as a stack of color filters 100 where the diver removes the top color filter 100 for use. The color filters 100 may be provided as separate stand-alone items. The color filters 100 may have a peel away film where peeling the film either creates a static charge in the color filter 100 or reveals adhesive which was covered by the film. The color filters 100 may be any shape, size, and thickness. The color filters 100 may be preshaped to match the shape of the lenses of the diving mask. Alternatively, in another embodiment, the color filter 100 may be provided in a standard shape which the user may customize by cutting into a specific desired shape.

In another embodiment of the invention the color filter 100 is utilized on a specialized diving mask 300. The specialized diving mask 300 utilizes a plurality of attachment points on the front of the diving mask 300 on which the color filter is removably secured to. In this embodiment the color filter 100 may secure directly to the attachment points of the specialized mask 300. Alternatively, the color filter 100 may be embedded in a separate color filter holder or frame and the holder or frame is directly attached to the attachment points on the diving mask 300. The attachment points may be any known mechanism for removably securing two things together. In the preferred embodiment the holder can snap onto the specialized mask 300. In another embodiment the color filter holder is hingedly attached to the specialized mask 300. In this embodiment, when a diver wants to utilize the color filter 100 the diver swivels the holder down and the color filter 100 rotates about the hinge into place in front of the mask 300. When the diver does not want to utilize the color filter 100 then the user swivels the frame up and the color filter 100 rotates about the hinge above the mask 300.

In another embodiment a plurality color filters 100 may be positioned on a single frame device which removably attaches to the diving mask 300. In the preferred embodiment the plurality of color filters 100 are all separate color filters 100. In this embodiment each of the color filters 100 slides or hinges into place in front of the diving mask 300 independently so that the user may use no color filter 100, one color filter 100, a combination of color filters 100, or all color filters 100 as desired by the diver. The color filters 100 may be removed from the frame and replaced so that a diver can customize the number of color filters 100 and types of colors used. For instance, the user may desire to utilize a yellow filter only, a red filter only, or both a yellow filter and a red filter simultaneously. Optionally, the user may desire to have two red filters. In this manner the diver may increase the intensity of the red color by using two red filters and thus enhance the color correction or contrast of the diving mask 300.

What has been described above includes examples of the claimed subject matter. It is, of course, not possible to describe every conceivable combination of components or methodologies for purposes of describing the claimed subject matter, but one of ordinary skill in the art can recognize that many further combinations and permutations of such matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

1. A device for adjusting underwater viewing comprising
a. a shaped lens consisting of a thin, transparent, tinted material, said shaped lens having a first side, said first side being a substantially flat, planar surface, a second side, said second side being a substantially flat, planar surface, and a peripheral edge disposed between said first side and said second side
i. wherein said shaped lens is an additive color filter configured to add missing wavelengths to light propagating through said shaped lens, said missing wavelengths being within a range of 577 nm to 750 nm;
ii. wherein said shaped lens is configured to be removably secured to the visor of a diving mask.

2. The device as in claim 1
a. Wherein said shaped lens is a thermoplastic material

3. The device as in claim 1
a. Wherein said shaped lens has a left portion and a right portion, said left portion and said right portion being mirrored images, said right portion and said left portion being substantially oval in shape

4. The device as in claim 1 wherein said shaped lens is an electrostatic material configured to cling to glass or thermoplastic.

5. The device as in claim 1 further comprising a means for removably securing said shaped lens to the visor of a diving mask.

6. The device as in claim 1 further comprising one or more suction cups disposed on said first side of said shaped lens.

7. The device as in claim 1 further comprising one or more clips disposed on said peripheral edge of said shaped lens.

8. The device as in claim 3 wherein said shaped lens has one or more openings, said device further comprising
a. a strap;
b. one or more strap clips disposed on said strap;
c. said strap passing through one of said one or more openings in said shaped lens;
d. said strap forming two loop sections, one loop section being disposed laterally from said right portion of said shaped lens and one loop section being disposed laterally from said left portion of said shaped lens.

9. The device as in claim 8
a. wherein said shaped lens is a thermoplastic material.

10. The device as in claim 2
a. wherein said shaped lens has a left portion and a right portion, said left portion and said right portion being mirrored images, said right portion and said left portion being substantially oval in shape;
b. said device further comprising a means for removably securing said shaped lens to the visor of a diving mask.

11. A device for adjusting underwater viewing comprising
a. two shaped lenses, each of said shaped lenses consisting of a thin, transparent, tinted material, said each of said shaped lenses having a first side, said first side being a substantially flat, planar surface, a second side, said second side being a substantially flat, planar surface, and a peripheral edge disposed between said first side and said second side
i. wherein each of said shaped lenses is an additive color filter configured to add missing wavelengths to light propagating through said shaped lens, said missing wavelengths being within a range of 577 nm to 750 nm;
ii. wherein said each of said shaped lenses is configured to be removably secured to the visor of a diving mask.

12. The device as in claim 11 wherein each of said shaped lenses is a thermoplastic material.

13. The device as in claim 11 wherein each of said shaped lenses are substantially oval in shape

14. The device as in claim 11 further comprising a means for removably securing each of said shaped lenses to the visor of a diving mask.

15. The device as in claim 11 further comprising one or more suction cups disposed on said first side of each of said shaped lenses.

16. The device as in claim 11 further comprising one or more clips disposed on said peripheral edge of each of said shaped lenses.

17. The device as in claim 11 wherein each of said shaped lenses has one or more openings, said device further comprising
a. a strap;
b. one or more strap clips disposed on said strap;
c. said strap passing through one of said one or more openings in each of said shaped lenses;
d. said strap forming two loop sections, one loop section being disposed laterally from one shaped lens and one loop section being disposed laterally from the other shaped lens.

18. The device as in claim 17
a. wherein each of said shaped lenses is a thermoplastic material;
b. wherein each of said shaped lenses are substantially oval in shape.

19. A method for enhancing the view of an underwater diving mask comprising
a. removably securing a shaped lens to the visor of a diving mask
i. said shaped lens consisting of a thin, transparent, tinted material, said shaped lens having a first side, said first side being a substantially flat, planar surface, a second side, said second side being a substantially flat, planar surface, and a peripheral edge disposed between said first side and said second side;
ii. wherein said shaped lens is an additive color filter configured to add missing wavelengths to light propagating through said shaped lens, said missing wavelengths being within a range of 577 nm to 750 nm;
iii. wherein said shaped lens is configured to be removably secured to the visor of a diving mask;
b. placing said diving mask bearing said shaped lens into an underwater environment.

20. The method as in claim 15 further comprising
a. detaching said shaped lens from said diving mask while said diving mask is in said underwater environment;
b. selecting an alternative shaped lens;
c. removably securing said alternative shaped lens to said visor of said diving mask while in said underwater environment.
